(19) United States
(12) Patent Application Publication
(10) Pub. No.: US 2015/0122072 A1
(43) Pub. Date: May 7, 2015

(54) TWIN ROTATION DRIVING APPARATUS

(71) Applicant: Industrial Technology Research Institute, Chutung (TW)

(72) Inventors: Chin-Fa WU, Chutung (TW); Chin-Mou HSU, Chutung (TW); Hsi-Hung HSIAO, Chutung (TW); Chiu-Hung LI, Chutung (TW)

(73) Assignee: Industrial Technology Research Institute, Chutung (TW)

(21) Appl. No.: 14/188,387

(22) Filed: Feb. 24, 2014

(30) Foreign Application Priority Data
Nov. 5, 2013 (TW) 102140074

(51) Int. Cl. B25J 17/00

(52) U.S. Cl. CPC B25J 17/00; Y10S 901/25
USPC 74/490.05; 901/25

(57) ABSTRACT

A twin rotation driving apparatus is provided, including a base body, an axle unit pivotally connected to the base body for carrying a workpiece, a first driving unit disposed on the base body and having a first gear set connected to the axle unit and a first motor coaxially connected to the first gear set, and a second driving unit disposed on the base body and having a second gear set connected to the axle unit and a second motor coaxially connected to the second gear set. The twin rotation driving apparatus includes two motors and two gear sets. Therefore, smaller motors can be included in the twin rotation driving apparatus, and the twin rotation driving apparatus is compact and can still generate great enough torques.

### CROSS-REFERENCE TO RELATED APPLICATIONS

This application claims priority to Taiwanese Patent Application No. 102140074, filed on Nov. 5, 2013, the disclosure of which is hereby incorporated by reference herein.

1. Technical Field

The present disclosure relates to rotatable machines, and, more particularly, to a twin rotation driving apparatus provided with a rotating body.

2. Description of Related Art

With the rapid increase of the operational speed of current computer numerical control (CNC) controllers as well as continuous advancement in computer-aided design (CAD) and computer-aided manufacturing (CAM), multi-axis machining technology has grown dramatically.

FIG. 1 is a 3D schematic view of a conventional multi-axis machining apparatus 8. The multi-axis machining apparatus 8 has a first track module 81 disposed on a machining platform 80 thereof, and an operation platform 82 disposed on the first track module 81. Workpieces (not shown) are placed on the operation platform 82.

The machining platform 80 has a frame body 83 and a second track module 84 disposed on the frame body 83. A third track module 85 is disposed on the second track module 84. The first track module 81, the second track module 84, and the third track module 85 are aligned in a vertical line so that an operational system that is movable in X, Y and Z directions is formed. A supporting element 86 is disposed on the third track module 85. The supporting element 86 has a rotary spindle head 1.

The rotary spindle head 1 comprises a fork base 10 and an axle unit 11. The fork base 10 is rotational about the supporting element 86 (as indicated by an arrow direction C in FIG. 1). A space 100 is between a left side 10a and a right side 10b of the shaft base body 10 for the axle unit 11 to be accommodated therein and axially connected to the fork base 10. The axle unit 11 has a spindle 110 for clamping a cutter 9 and a rotatory base body 111 accommodated in the space 100 and driving the spindle 110. The rotatory base body 111 swings in the space 100 (as indicated by an arrow direction A), and the cutter 9 is driven to swing and the fork base 10 is driven to rotate, so as to accomplish a multi-axis machining function.

The rotary spindle head 1 can be driven by the servo motor provided with the gear reducer, driven by the torque motor, or driven by the torque motor provided with the gear reducer.

U.S. Pat. Nos. 5,257,883 and 5,996,329 disclose the servo motor provided with the gear reducer. Since the servo motor outputs a torque that is small, the gear reducer has to have a reduction ratio as high as 10˜100, so as to amplify the torque and meet the work requirement for the rotary spindle head 1. The gear reducer comprises worm wheels and belt wheels. However, the worm wheels are made of copper and are worn out easily, causing the gap between gear teeth to exceed a tolerate value. The drawbacks facilitate the disclosure of the torque motor that drives the rotary spindle head 1 directly.

Taiwanese Patent No. 1314075 (the counterpart of U.S. Pat. No. 7,293,340) discloses the torque motors that drive the rotary spindle head 1 directly. The torque motor, though having a high torque value, a low power loss, and a high rotational speed, is costly and bulky as a higher torque is required.

U.S. Pat. No. 7,470,095 discloses a torque motor provided with a gear reducer. The torque motor is not coaxially connected to the rotatory shaft of the rotary spindle head 1. Therefore, the specificity of the torque motor and the disposing location of the transmission mechanism are limited. Moreover, inputs and outputs are not coaxial, thus achieving no dynamic equilibrium.

Taiwanese Patent Publication No. 201204506 discloses a torque motor (not shown) and a planetary gear reducer (not shown) are disposed coaxially on the left side 10a (or the right side 10b) of the shaft base body 10 of the rotary spindle head 1, so as to increase the torque density and distribute the loading evenly.

However, during the operation of the planetary gear reducer described in Taiwanese Patent Publication No. 201204506, the positioning accuracy and repeatability accuracy of the axle unit 11 (as shown in FIG. 1) will be affected by the gaps resulted from the engagements of the teeth of the planetary gears, the sun gear and the ring gear.

Thus, there is an urgent need to solve the problems experienced in the conventional technology.

### SUMMARY

In light of the foregoing drawbacks of the prior art, the present disclosure proposes twin rotation driving apparatus, comprising: a base body; an axle unit pivotally connected to the base body for carrying a workpiece; a first driving unit disposed on the base body and having a first gear set connected to the axle unit and a first motor coaxially connected to the first gear set; and a second driving unit disposed on the base body, being coaxial with the first driving unit, and having a second gear set connected to the axle unit and a second motor coaxially connected to the second gear set.

In an embodiment, two driving units are connected to the opposite sides of the base body with the same axis, enabling the driving unit to drive from two sides of the base body which even out the torque generated, and moreover, the two motors are coordinated to control the drive, thereby eliminating the gaps between engaged gear teeth.

In another embodiment, the two gear sets are planetary modules functioning as a speed reducing mechanism, and the design of two gear sets enables more planetary gears to be disposed so as to distribute the loading carried.

In summary, the present disclosure utilizes two motors (torque motors or servo motors), along with different gear sets to generate torque, which not only enables larger torque to be exerted by motors that are smaller in scale, but the overall twin rotation driving apparatus has a smaller turning diameter and smaller size, allowing the operation machine to have better performance in machining.

### BRIEF DESCRIPTION OF DRAWINGS

The present disclosure can be more fully understood by reading the following detailed description of the preferred embodiments, with reference made to the accompanying drawings, wherein:

FIG. 1 is a schematic view of a conventional multi-axis machining device;

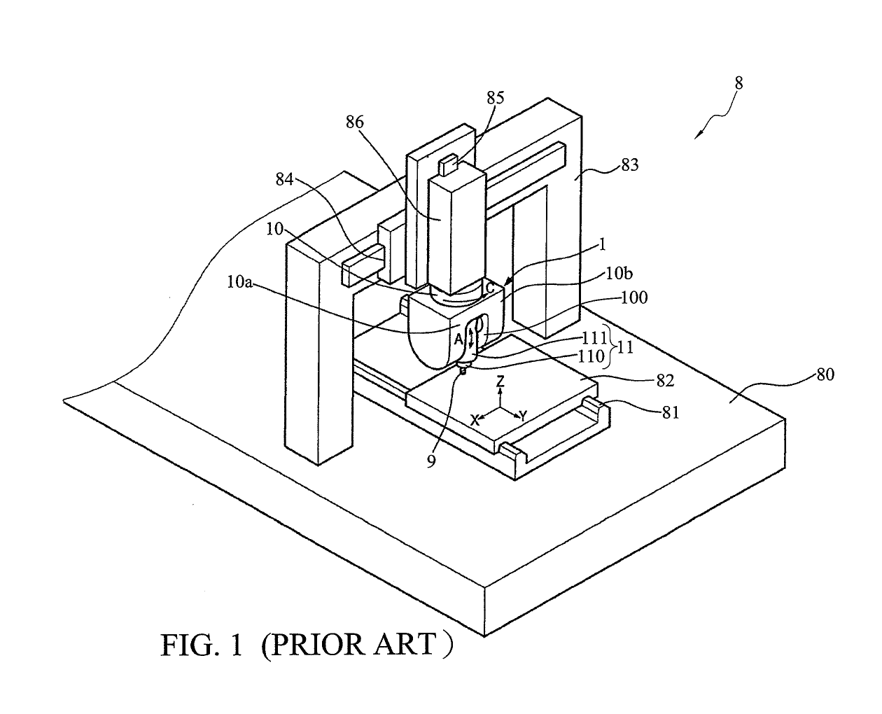

FIG. 2 is a schematic view of a twin rotation driving apparatus according to the present disclosure;

FIG. 3 is a front cross-sectional view of the twin rotation driving apparatus according to the present disclosure;

FIG. 4 is a lateral schematic view of the twin rotation driving apparatus disclosed according to the present disclosure; and

FIG. 5 is a top schematic view of the twin rotation driving apparatus disclosed according to the present disclosure.

### DETAILED DESCRIPTION

In the following detailed description, for purposes of explanation, numerous specific details are set forth in order to provide a through understanding of the disclosed embodiments. It will be apparent, however, that one or more embodiments may be practiced without these specific details. In other instances, well-known structures and devices are schematically shown in order to simplify the drawing.

It is to be understood that the scope of the present disclosure is not limited to the disclosed embodiments. On the contrary, it is intended to cover various modifications and similar arrangements. The scope of the claims, therefore, should be accorded the broadest interpretation so as to encompass all such modifications and similar arrangements. In addition, words such as “on”, “top” and “a” are used to explain the preferred embodiment of the present disclosure only and should not limit the scope of the present disclosure.

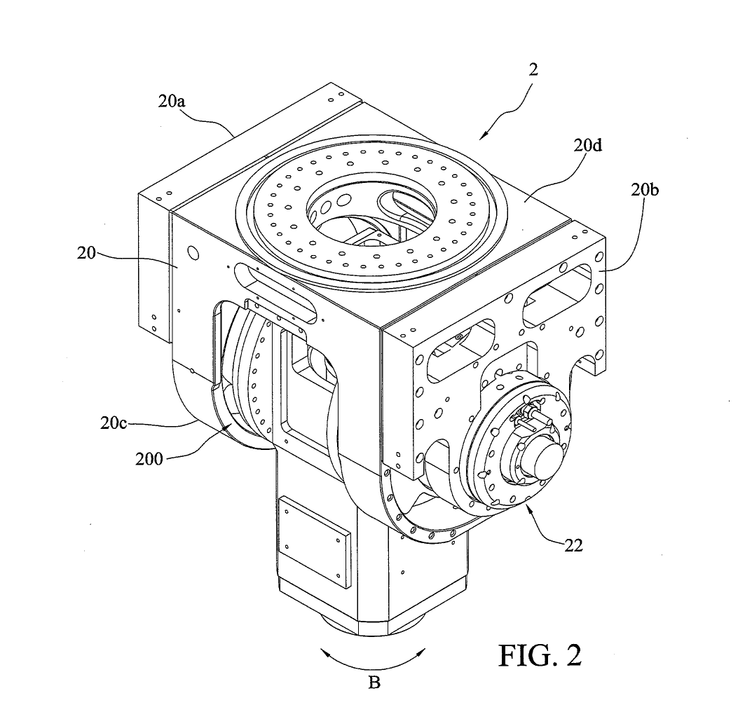

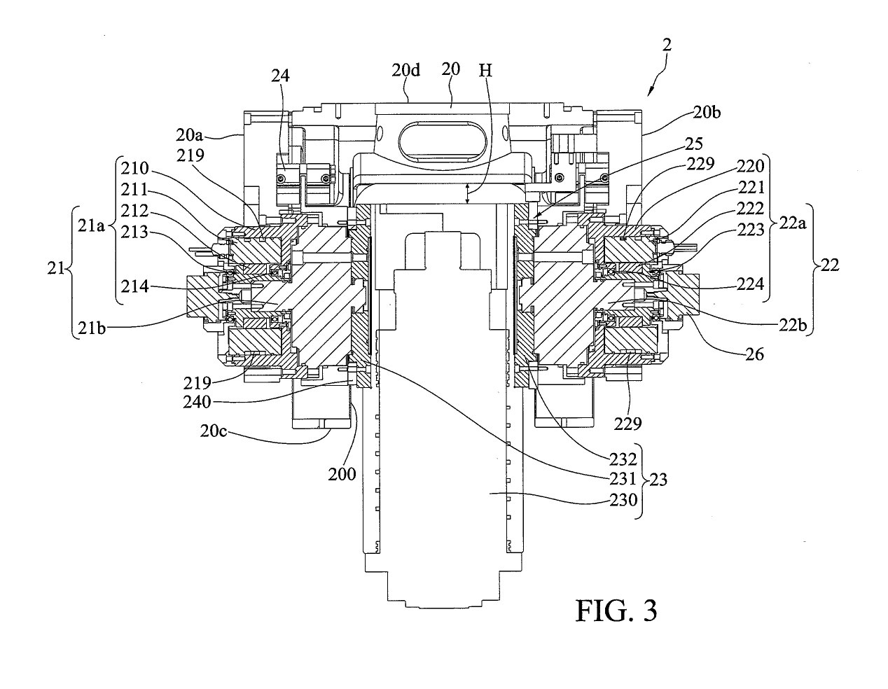

FIGS. 2 and 3 show a twin rotation driving apparatus 2 according to the present disclosure. The twin rotation driving apparatus 2 comprises a base body 20, an axle unit 23, a first driving unit 21, and a second driving unit 22.

The base body 20 has a first side 20a (the left side, for example), and an opposing second side 20b (the right side, for example). A dent 200 is disposed on a bottom surface 20c of the base body 20 and between the first side 20a and the second side 20b, to form a reverse U-shaped fork structure. The machine table, rotary or stationary, of a machine, vertical or horizontal, can be disposed on a top surface 20d of the base body 20. The first side 20a and the second side 20b of the base body 20 have hollow structures, for the first driving unit 21 and the second driving unit 22 to be accommodated therein, respectively.

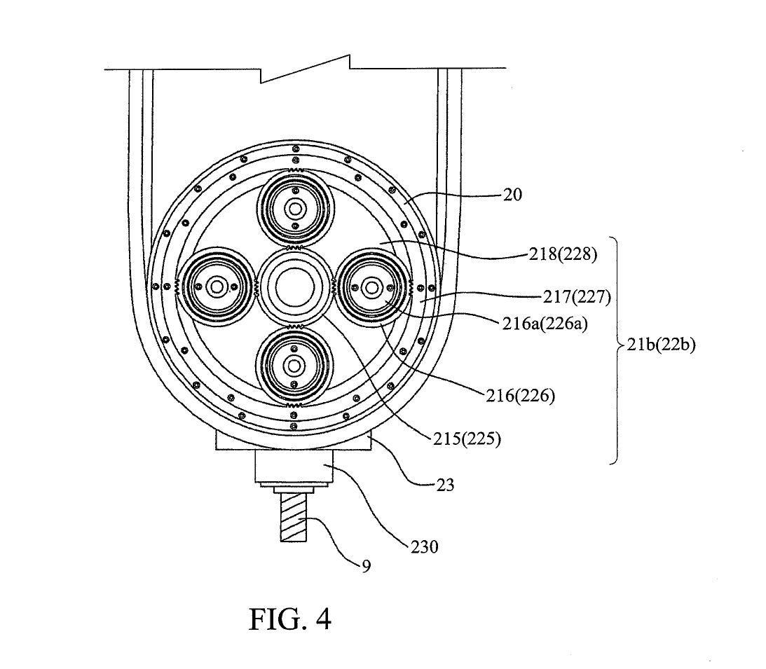

The axle unit 23 is pivotally connected between the first side 20a and the second side 20b of the base body 20 and can be accommodated in the dent 200, for a workpiece to be carried thereon. The workpiece is, but not limited to a cutter 9 (as shown in FIG. 4) or a mechanical limb (e.g., a mechanical arm). The axle unit 23 has a spindle 230 for clamping the workpiece, and rotatory base bodies 231 and 232 pivotally connected to a first gear set 21b and a second gear set 22b, respectively, for driving the spindle 230, as shown in FIG. 3. A gap H exists between the axle unit 23 and a top surface of the dent 200. As shown in FIG. 3, the spindle 230 swings within the dent 200 (indicated as an arrow direction B) to drive the workpiece to swing back and forth.

The first driving unit 21 is disposed on the first side 20a of the base body 20, and has a first motor 21a and the first gear set 21b. The first motor 21a is coaxially connected to the first gear set 21b, and the first gear set 21b is connected to the axle unit 23. The first motor 21a is, but not limited to a torque motor or a servo motor. The first gear set 21b is a gear reducer, such as a planetary gear reducer, a cycloidal gear reducer, a pin gear cycloidal reducer, a cycloidal planetary gear reducer, a planetary cycloidal pin gear reducer, and a simple harmonic drive gear reducer.

The first motor 21a has a motor base body 210 positioned on the base body 20, a ring motor stator 211 at the inner periphery of the motor base body 210, a motor rotor 212 pivotally connected inside the motor stator 211, and a shaft 213 connected to the motor rotor 212. The shaft 213 and the motor base body 210 are connected using a bearing 214, so as to generate a torque under the electro-magnetic function so as to enable the shaft 213 to drive the first gear set 21b.

As shown in FIG. 4, the first gear set 21b comprises a sun gear 215, a plurality of planetary gears 216, a ring gear 217, and a planetary frame 218. The first motor 21a drives the sun gear 215, such that the planetary gears 216 are engaged between and around the sun gear 215 and the ring gear 217. The ring gear 217 and the sun gear 215 are coaxially disposed on the base body 20. The planetary gears 216 are pivotally connected to the planetary frame 218 using shaft elements 216a. The planetary frame 218 is connected to the axle unit 23.

The second driving unit 22 is disposed on the second side 20b of the base body 20, being coaxial with the first driving unit 21, and has a second motor 22a and the second gear set 22b. The second motor 22a is coaxially connected to the second gear set 22b, and the second gear set 22b is connected to the axle unit 23. The second motor 22a is, but not limited to a torque motor or a servo motor. The second gear set 22b is a gear reducer, such as a planetary gear reducer, a cycloidal gear reducer, a pin gear cycloidal reducer, a cycloidal planetary gear reducer, a planetary cycloidal pin gear reducer, and a simple harmonic drive gear reducer.

The second motor 22a has a motor base body 220 positioned on the base body 20, a ring motor stator 221 disposed at the inner periphery of the motor base body 220, a motor rotor 222 pivotally connected inside the motor stator 221, and a shaft 223 connected to the motor rotor 222. The shaft 223 and the motor base body 220 are connected using a bearing 224, so as to generate a torque under the electro-magnetic function so as to enable the shaft 223 to drive the second gear set 22b.

As shown in FIG. 4, the second gear set 22b comprises a sun gear 225, a plurality of planetary gears 226, a ring gear 227, and a planetary frame 228. The second motor 22a drives the sun gear 225, such that the planetary gears 226 are engaged between and around the sun gear 225 and the ring gear 227. The ring gear 227 and the sun gear are coaxially disposed on the base body 20. The planetary gears 226 are pivotally connected to the planetary frame 228 using shaft elements 226a. The planetary frame 228 is connected to the axle unit 23.

When the shaft 213, 223 of the first and second motor 21a, 22a drives the sun gear 215, 225, the planetary gears 216, 226 not only rotate on its own, but also have revolution movement resulting in speed reduction, allowing the planetary frame 218, 228 to rotate and drive the rotatory base bodies 231 and 232 and the spindle 230 of the axle unit 23 to rotate (or to swing).

In worm wheels or gear reducers, each of the gears has only a single tooth for engagement generally. Therefore, all the stresses will be concentrated on a single point, and the gear teeth are easily damaged, and the transmission efficiency is poor. In the planetary gear reducer, a plurality of contact points are available when the teeth of the planetary gears are engaged with the teeth of the sun gear and the ring gear. As a result, with regard to the same torque the damage caused for the teeth is much less. Since the planetary gear reducers are compactly configured in concentric circles, they have the advantages of smaller in size, lightweight, high transmission efficiency, evened loading, high structural stiffness and well dynamic balance. Therefore in the present embodiment of the present disclosure, the planetary gear set with a plurality of planetary gears is used for the first and second gear set 21b, 22b as the gear reducer.

The first motor 21 a and the second motor 22a rotate in the same or opposite direction. During operation, the first motor 21a and the second motor 22a are coordinated to control the drive, allowing the torque exerted by the first motor 21a against the first gear set 21b and the axle unit 23, and the torque exerted by the second motor against the second gear set 22b and the axle unit 23 will never be less than the static friction torque at the same time. Therefore, a torque exerted by at least one of the first and second motors 21a and 21b against the gear set and the axle unit 23 connected therewith will always greater than the static friction torque, and, as a result, any gaps between engaged teeth of the active gears (e.g., the sun gears 215, 225) and the passive gears (e.g., the planetary gears 216, 226 and the ring gears 217, 227) can be desirably eliminated.

When the torques exerted by the two motors are at opposite directions, the overall torque exerted will be zero, which makes the axle unit 23 to be in a stationary state.

When the toques exerted by the two motors are at the same direction, the overall torque exerted will be the sum of the torques exerted by the two motors, so as to increase the running torque and speed of the axle unit 23, as well as the carrier cutting ability or increase the loading of the mechanical arms. For instance, when the same amount of torques exerted by the first driving unit 21 and the second driving unit 22 are at the same direction, the axle unit 23 is able to generate two times of running torque.

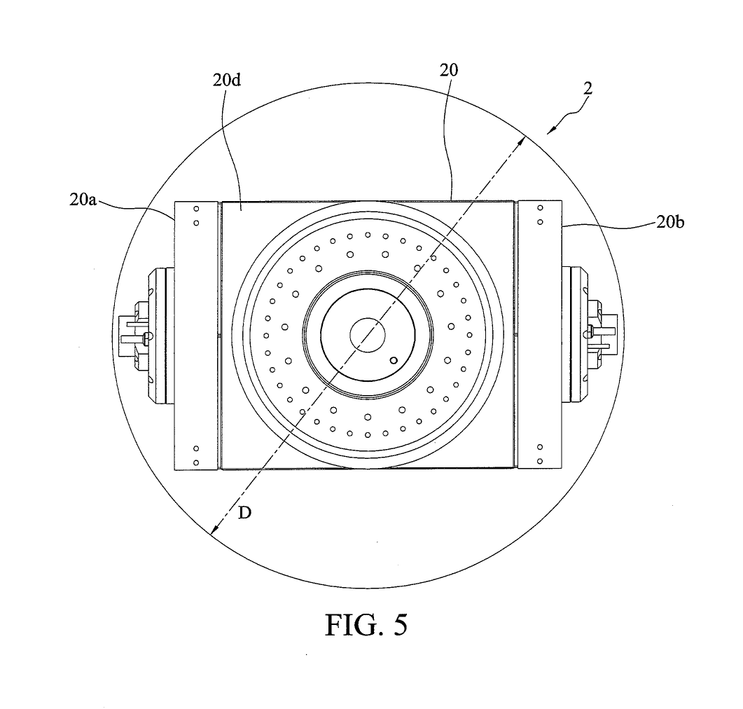

The twin rotation driving apparatus 2 disclosed by the present disclosure utilizes the design of driving units 21, 22 on the inner side of the base body 20, to produce much greater torque for torque motors that are much smaller in scale. For instance, in one preferred embodiment, with the driving units 21, 22 that is completely the same, when the maximum torque that the single torque motor can generate is 38.2 Nm, the maximum speed that the torque motor can generate is 4500 rpm, and the reduction ratio of the gear reducer is 57, the maximum torque to drive the axle unit 23 is 2177 Nm (38.2×57×1=2177.4 Nm), the swing movement speed is 79 rpm (4500÷57=78.95 rpm), and the turning diameter D (as shown in FIG. 5) of the twin rotation driving apparatus 2 is 697 mm. Compared with conventional rotatory drive apparatus in which two torque motors directly drive the axle unit, the maximum torque of a single torque motor is 680 Nm, the maximum overall torque that the two torque motors can generate to drive the axle unit is 1360 Nm (680 Nm×2=1360 Nm), the swing movement speed is 60 rpm, and the turning diameter D is 780 mm, the present disclosure is smaller in size (smaller turning diameter), has a greater torque to drive the axle unit, and has a higher swing speed.

Moreover, since the twin rotation driving apparatus 2 has a smaller turning diameter D (as shown in FIG. 5) and a smaller size, a working machine having the twin rotation driving apparatus 2 has stronger machining capability (such as cutting) and larger working space and higher machining flexibility.

In an embodiment, the base body 20 further has a brake 24 (including a brake disk 240), an angle encoder 25, and a rotary encoder 26, as shown in FIG. 3, to provide clamping, accurate positioning and speed control. In an embodiment, the brake 24, the angle encoder 25, and the rotary encoder 26 are installed on the inner part of the first side 20a and the second side 20b of the base body 20 according to the practical requirement, to effectively utilize the hollow space of the base body. The brake 24, the angle encoder 25, and the rotary encoder 26 in the present disclosure can be of many different variations and are not limited to any particular kind.

In an embodiment, the first motor 21a and/or second motor 22a has a cooling passage 219,229, as shown in FIG. 3, allowing a cooling fluid to pass therethrough. The cooling passage 219, 229 is located between the outer periphery of the motor stator 211, 221 and the motor base body 210,220.

The twin rotation driving apparatus disclosed by the present disclosure utilizes a fork structure to symmetrically dispose one motor and one gear reducer on each side of the two sides with the same axis, to drive the spindle to have swing movement. This design enables a plurality of gears (such as planetary gears) to be disposed in order to increase the area for carrying loading and also even out the distribution of loading.

Moreover, the driving units on the two sides providing power to the axle unit to drive the spindle to swing have the advantage of evening out the torque driving the swing movement of the spindle, and thus providing a higher structural stiffness and better dynamic balance.

In addition, the heat produced by the two motors are distributed in a symmetrical way against two sides of the base body, therefore is beneficial for the thermal deformation compensation of the spindle, so as to increase the accuracy in machining.

Furthermore, two motors which are coordinated to control the drive eliminate the gaps between the engaged teeth of the planetary gears, sun gears, and the ring gears.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A twin rotation driving apparatus, comprising:
a base body;
an axle unit pivotally connected to the base body for carrying a workpiece;
a first driving unit disposed on the base body and having a first gear set connected to the axle unit and a first motor coaxially connected to the first gear set; and
a second driving unit disposed on the base body, being coaxial with the first driving unit, and having a second gear set connected to the axle unit and a second motor coaxially connected to the second gear set.

2. The twin rotation driving apparatus of claim 1, wherein the first motor and the second motor rotate in the same or opposite direction.

3. The twin rotation driving apparatus of claim 2, wherein the first motor and the second motor operate in association with each other.

4. The twin rotation driving apparatus of claim 1, wherein the base body has a first side and a second side opposite to the first side, the axle unit is pivotally connected between the first side and second side of the base body, the first driving unit is disposed on the first side of the base body, and the second driving unit is disposed on the second side of the base body.

5. The twin rotation driving apparatus of claim 4, wherein the base body further comprises a dent between the first side and the second side to accommodate the axle unit therein.

6. The twin rotation driving apparatus of claim 1, further comprising a brake, an angle encoder and a rotary encoder disposed on the base body to clamp and position the axle unit and control the rotational speed of the axle unit.

7. The twin rotation driving apparatus of claim 1, wherein the workpiece carried by the axle unit is a cutter or a mechanical limb.

8. The twin rotation driving apparatus of claim 1, wherein the first gear set is a planetary gear reducer, a cycloidal gear reducer, a pin gear cycloidal reducer, a cycloidal planetary gear reducer, a planetary cycloidal pin gear reducer, or a simple harmonic drive gear reducer.

9. The twin rotation driving apparatus of claim 8, wherein the planetary gear reducer comprises a sun gear driven by the first motor, a ring gear being coaxial with the sun gear and mounted to the base body, a plurality of planetary gears engaged around and between the sun gear and the ring gear, and a planetary frame pivotally connected to the planetary gears and connected to the axle unit.

10. The twin rotation driving apparatus of claim 1, wherein the second gear set is a planetary gear reducer, a cycloidal gear reducer, a pin gear cycloidal reducer, a cycloidal planetary gear reducer, a planetary cycloidal pin gear reducer, or a simple harmonic drive gear reducer.

11. The twin rotation driving apparatus of claim 10, wherein the planetary gear reducer comprises a sun gear driven by the second motor, a ring gear being coaxial with the sun gear and mounted to the base body, a plurality of planetary gears engaged around and between the sun gear and the ring gear, and a planetary frame pivotally connected to the planetary gears and connected to the axle unit.

12. The twin rotation driving apparatus of claim 1, wherein the first motor has a cooling passage for a cooling fluid to pass therethrough.

13. The twin rotation driving apparatus of claim 1, wherein the second motor has a cooling passage for a cooling fluid to pass therethrough.

14. The twin rotation driving apparatus of claim 1, wherein the first motor and the second motor are torque motors or servo motors.
